(19) United States
(12) Patent Application Publication
(10) Pub. No.: US 2026/0032205 A1
(43) Pub. Date: Jan. 29, 2026

(54) IMAGE FORMING APPARATUS

(71) Applicant: SEIKO EPSON CORPORATION, TOKYO (JP)

(72) Inventors: Satoshi NAKATA, Matsumoto-shi (JP); Katsumi YAMADA, Matsumoto-shi (JP); Kanji MOMOSE, Suwa-shi (JP); Masahito TATSUMI, Suwa-shi (JP); Hirokazu ANADA, Suwa-shi (JP)

(21) Appl. No.: 19/279,276

(22) Filed: Jul. 24, 2025

(30) Foreign Application Priority Data
Jul. 25, 2024 (JP) 2024-119342

(51) Int. Cl. H04N 1/00; B41J 3/44

(52) U.S. Cl. CPC H04N 1/00525; B41J 3/44; H04N 1/00602; H04N 1/00604; H04N 1/00615; H04N 1/00795; H04N 2201/0081

(57) ABSTRACT

An image forming apparatus including an image forming apparatus body section and an image reader, the image reader being provided in an upper portion of the image forming apparatus body section, and including a body tray, an extractable tray that is extractable with respect to the body tray toward a first direction side from a stored position to an extracted position, and a document edge guide that is movable in a width direction, the document edge guide being configured to be operable from the first direction side.

The present application is based on, and claims priority from JP Application Serial Number 2024-119342, filed Jul. 25, 2024, the disclosure of which is hereby incorporated by reference herein in its entirety.

### BACKGROUND

### 1. Technical Field

The present disclosure relates to an image forming apparatus.

### 2. Related Art

Various image forming apparatuses have been used. Among these apparatuses, there is an image forming apparatus including an image reader that is disposed in an upper portion of an image forming apparatus body section and reads a conveyed document. For example, JP-A-2023-167889 discloses an image forming apparatus including an image reader capable of reading a document conveyed to an upper portion of an image forming apparatus body section.

JP-A-2023-167889 is an example of the related art.

In an image forming apparatus that includes an image reader that is disposed in an upper portion of an image forming apparatus body section and reads a conveyed document, such as the image forming apparatus disclosed in JP-A-2023-167889, a document edge guide is provided in a document placement portion, and the document edge guide is moved in the width direction in accordance with the width of the document. However, in the related-art image forming apparatus, which includes the image reader, which is disposed in the upper portion of the image forming apparatus body section and reads the conveyed document, the operability of the document edge guide to be moved in the width direction is poor. For example, the image forming apparatus disclosed in JP-A-2023-167889 feeds a document in the direction from the side in front of the apparatus (front side) toward the rear side of the apparatus, and a document discharger discharges the document in the direction from the rear side of the apparatus toward the front side of the apparatus.

In the configuration described above, since the image forming apparatus can be operated from the front side of the apparatus, the image forming apparatus can be installed in a narrow space. In the configuration described above, however, since the position of the document edge guide is located on the rear side of the apparatus, it is prerequisite to access the document edge guide from the upper side of the apparatus. However, when the thus configured image forming apparatus is installed, for example, on a shelf or the like having a limited upper space, it is difficult to access the document edge guide from the upper side of the apparatus. However, in the configuration described above, since it is difficult to access the document edge guide from the front side of the apparatus, the operability of the document edge guide to be moved in the width direction is poor, so that the image forming apparatus cannot be installed on a shelf or the like having a substantially limited upper space.

### SUMMARY

An image forming apparatus according to an aspect of the present disclosure to solve the problems described above is an image forming apparatus operable from a first direction side, the image forming apparatus including: an image forming apparatus body section configured to feed a sheet in a direction from the first direction side toward a second direction side opposite the first direction side, and discharge the sheet in a direction from the second direction side toward the first direction side; and an image reader configured to feed a document in the direction from the first direction side toward the second direction side, and discharge the document in the direction from the second direction side toward the first direction side, the image reader being provided in an upper portion of the image forming apparatus body section, and including a body an tray, extractable tray extractable with respect to the body tray toward the first direction side from a stored position to an extracted position, and a document edge guide movable in a width direction that intersects with a feeding direction of the document, and the document edge guide being configured to be operable from the first direction side.

### BRIEF DESCRIPTION OF THE DRAWINGS

FIG. 1 is a perspective view of an image forming apparatus according to a first embodiment of the present disclosure, and shows a state in which an extractable tray is at a stored position.

FIG. 2 is a schematic view showing the internal configuration of the image forming apparatus shown in FIG. 1.

FIG. 3 is a perspective view of the image forming apparatus shown in FIG. 1, and shows a state in which the extractable tray is at an extracted position.

FIG. 4 is a perspective view of an image reader of an image forming apparatus according to a second embodiment of the present disclosure, and shows a state in which an extractable tray is at a stored position.

FIG. 5 is a perspective view of the image reader shown in FIG. 4, and shows a state in which the extractable tray is at an extracted position.

FIG. 6 is a perspective view showing a moving mechanism of a document edge guide of the image reader shown in FIG. 4 viewed from the side facing the bottom of the image reader.

FIG. 7 is a perspective view showing the moving mechanism of the document edge guide of the image reader shown in FIG. 4 viewed from the side facing the top of the image reader.

FIG. 8 is a perspective view of an image reader of an image forming apparatus according to a third embodiment of the present disclosure, and shows a state in which an extractable tray is at a stored position.

FIG. 9 is a perspective view showing a moving mechanism of a document edge guide of the image reader shown in FIG. 8 viewed from the side facing the top of the image reader.

FIG. 10 is a perspective view of an image reader of an image forming apparatus according to a fourth embodiment of the present disclosure, and shows a state in which an extractable tray is at a stored position.

FIG. 11 is a perspective view showing a moving mechanism of a document edge guide of the image reader shown in FIG. 10 viewed from the side facing the top of the image reader.

### DESCRIPTION OF EMBODIMENTS

The present disclosure will be schematically described below.

An image forming apparatus according to a first aspect of the present disclosure is an image forming apparatus operable from a first direction side, the image forming apparatus including: an image forming apparatus body section configured to feed a sheet in a direction from the first direction side toward a second direction side opposite the first direction side, and discharge the sheet in a direction from the second direction side toward the first direction side; and an image reader configured to feed a document in the direction from the first direction side toward the second direction side, and discharge the document in the direction from the second direction side toward the first direction side, the image reader being provided in an upper portion of the image forming apparatus body section, and including a body tray, an extractable tray extractable with respect to the body tray toward the first direction side from a stored position to an extracted position, and a document edge guide movable in a width direction that intersects with a feeding direction of the document, and the document edge guide being configured to be operable from the first direction side.

According to the present aspect, the document edge guide is configured to be operable from the first direction side. The document edge guide can therefore be accessed from the first direction side corresponding to the front side of the apparatus, so that the operability of the document edge guide to be moved in the width direction can be improved.

According to a second aspect of the present disclosure, in the image forming apparatus according to the first aspect, the extractable tray is located above the body tray when the extractable tray is at the stored position, and the document edge guide is disposed at the extractable tray.

According to the present aspect, the extractable tray is located above the body tray when the extractable tray is at the stored position, and the document edge guide is disposed at the extractable tray. The configuration described above allows improvement in the operability of the document edge guide to be moved in the width direction not only when the document edge guide is at the extracted position but also when the document edge guide is at the stored position.

According to a third aspect of the present disclosure, in the image forming apparatus according to the second aspect, when the image forming apparatus is viewed from above in a state in which the extractable tray is located at the extracted position, at least a portion of the document edge guide is located at a position shifted toward the first direction side from an enclosure surface of the image reader that is a surface on the first direction side.

According to the present aspect, when the image forming apparatus is viewed from above with the extractable tray being at the extracted position, at least a portion of the document edge guide is located at a position shifted toward the first direction side from the enclosure surface of the image reader, which is a surface on the first direction side. The configuration described above allows the user to readily access the document edge guide from the first direction side corresponding to the front side of the apparatus, which can particularly improve the operability of the document edge guide to be moved in the width direction.

According to a fourth aspect of the present disclosure, the image forming apparatus according to the first aspect further includes a manually operable operation section; and a moving unit linked to the operation section and the document edge guide, the document edge guide is disposed at the body tray, and the operation section is disposed at an enclosure surface of the image reader that is a surface on the first direction side.

According to the present aspect, a manually operable operation section, and a moving unit linked to the operation section and the document edge guide are provided. The configuration described above readily allows the document edge guide to be moved via the operation section. The document edge guide is disposed at the body tray, and the operation section is disposed at an enclosure surface of the image reader that is a surface on the first direction side. The configuration described above allows the user to access the operation section from the first direction side corresponding to the front side of the apparatus, which can particularly improve the operability of the document edge guide to be moved in the width direction.

According to a fifth aspect of the present disclosure, in the image forming apparatus according to the fourth aspect, the operation section is a rotary dial or a lever.

According to the present aspect, the operation section is a rotary dial or a lever. The configuration described above readily allows the user to move the document edge guide by rotating the operation section or moving the operation section in the forward-rearward direction.

According to a sixth aspect of the present disclosure, in the image forming apparatus according to the fifth aspect, the operation section is the rotary dial, and the rotary dial is configured to move the document edge guide in the width direction via at least one of a belt, a pulley, or a gear.

According to the present aspect, the operation section is a rotary dial, and the rotary dial is configured to move the document edge guide in the width direction via at least one of a belt, a pulley, or a gear. The configuration described above allows the operation section to have a simple configuration and to be reduced in size.

According to a seventh aspect of the present disclosure, in the image forming apparatus according to the fifth aspect, the operation section is the lever, and the lever is configured to move the document edge guide in the width direction via at least one of a belt, a pulley, or a gear.

According to the present aspect, the operation section is a lever, and the lever is configured to move the document edge guide in the width direction via at least one of a belt, a pulley, or a gear. The configuration described above allows the operation section to have a simple configuration and to be reduced in size.

According to an eighth aspect of the present disclosure, in the image forming apparatus according to the fourth aspect, the document edge guide is configured with multiple document edge guides, and the operation section is integrated with at least one of the document edge guides.

According to the present aspect, the document edge guide is configured with multiple document edge guides, and the operation section is integrated with at least one of the document edge guides. The configuration described above can eliminate the need to provide a section that links the operation section to the document edge guide, so that the number of parts can be reduced, and an increase in size of the apparatus can be suppressed.

According to a ninth aspect of the present disclosure, the image forming apparatus according to any one of the first to eighth aspects further includes an operation section configured to accept an operation instruction, and the operation section is disposed at an enclosure surface of the image forming apparatus body section that is a surface on the first direction side or an enclosure surface of the image reader that is a surface on the first direction side.

According to the present aspect, an operation section configured to accept an operation instruction is provided, and the operation section is disposed at an enclosure surface of the image forming apparatus body section that is a surface on the first direction side, or an enclosure surface of the image reader that is a surface on the first direction side. The configuration described above allows improvement in the operability of the operation section in addition to the operability of the document edge guide to be moved in the width direction.

According to a tenth aspect of the present disclosure, the image forming apparatus according to any one of the fourth to eighth aspects further includes an operation section configured to accept an operation instruction, and the operation section is disposed at an enclosure surface of the image forming apparatus body section that is a surface on the first direction side or an enclosure surface of the image reader that is a surface on the first direction side, which is a side different in the width direction from a side on which the operation section is provided.

According to the present aspect, an operation section that accepts an operation instruction is provided, and the operation section is disposed at an enclosure surface of the image forming apparatus body section that is a surface on the first direction side or an enclosure surface of the image reader that is a surface on the first direction side, which is a side different in the width direction from a side on which the operation section is provided. The configuration described above allows improvement in the operability of the operation section in addition to the operability of the document edge guide to be moved in the width direction, and further allows the user to use the operation section while viewing the operation section without the field of view being blocked by the user's hand or the like.

According to an eleventh aspect of the present disclosure, the image forming apparatus according to any one of the fourth to eighth aspects and the tenth aspect further includes a light emitter at or near the operation section, and the light emitter is configured to emit light when the extractable tray is extracted to the extracted position.

According to the present aspect, a light emitter is provided at or near the operation section, and the light emitter is configured to emit light when the extractable tray is extracted to the extracted position. The configuration described above allows the user to readily recognize the position of the operation section used to move the document edge guide.

According to a twelfth aspect of the present disclosure, in the image forming apparatus according to any one of the fourth to eighth aspects and the tenth and eleventh aspects, a transparent or semitransparent region is provided around at least one of the extractable tray or the operation section.

According to the present aspect, a transparent or semitransparent region is provided around at least one of the extractable tray or the operation section. The configuration described above allows the user to readily recognize at least one of the position of the document edge guide after it is moved or the position of the operation section used to move the document edge guide.

### First Embodiment

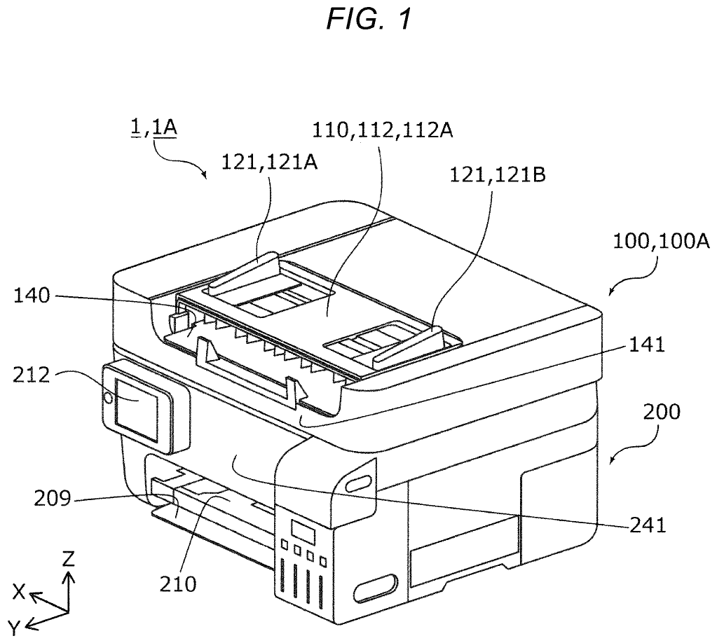

The present disclosure will be specifically described below. An image forming apparatus 1A according to a first embodiment will first be described as an example of an image forming apparatus 1 according to the present disclosure with reference to FIGS. 1 to 3. In the X-Y-Z coordinate system shown in the drawings, the X-axis direction is the lateral direction, that is, the width direction of the apparatus, the Y-axis direction is the frontward direction (direction toward front) and the rearward direction of the apparatus, and the Z-axis direction is the height direction and the gravity direction of the apparatus. The direction in which a medium P is conveyed is referred to as “downstream”, and the direction opposite the medium conveying direction is referred to as “upstream”. In the drawings, some constituent members are omitted or simplified in some cases to facilitate understanding of an internal configuration and the like.

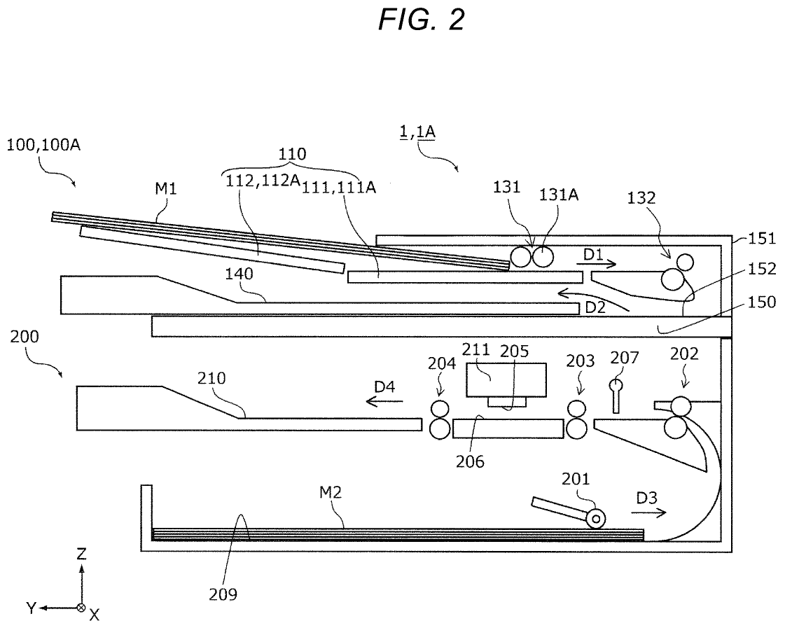

The image forming apparatus 1A according to the present embodiment includes an image reader 100, which reads an image such as characters and pictures drawn on a document, and an image forming apparatus body section 200, which is an inkjet recorder, as shown in FIGS. 1 to 3. From another viewpoint, the image forming apparatus 1A according to the present embodiment includes the image forming apparatus body section 200, which feeds a sheet M2 in a feeding direction D3 from the +Y direction side, which is a first direction side, toward the −Y direction side, which is a second direction side opposite the first direction side, and discharges the sheet M2 in a discharge direction D4 from the second direction side toward the first direction side, as shown in FIG. 2. Note in the image forming apparatus 1A according to the present embodiment that the first direction side corresponds to a frontward direction side of the apparatus, that is, a front side that is a side on which a user operates the image forming apparatus 1A, for example, a side provided with an operation panel 212, which accepts an operation instruction from the user.

The image forming apparatus 1A according to the present embodiment further includes an image reader 100A, which is an example of the image reader 100, which feeds a document M1 in a feeding direction D1 from the first direction side toward the second direction side, and discharges the document M1 in a discharging direction D2 from the second direction side toward the first direction side, as shown in FIG. 2. As described above, the image forming apparatus 1A according to the present embodiment includes the image forming apparatus body section 200, which conveys the sheet M2 in the frontward direction and the rearward direction of the apparatus, and the image reader 100, which conveys the document M1 in the frontward direction and the rearward direction of the apparatus. The thus configured image forming apparatus 1A according to the present embodiment can be installed in a narrow space.

The image forming apparatus body section 200 of the image forming apparatus 1A according to the present embodiment includes a tray 209, on which the sheet M2, which is an image formation medium on which an image is formed, is placed, as shown in FIGS. 1 and 2. The image forming apparatus body section 200 includes a feeding roller 201, as shown in FIG. 2. The sheet M2 placed on the tray 209 is fed in the feeding direction D3 by the feeding roller 201.

The image forming apparatus body section 200 includes multiple conveying roller pairs such as conveying roller pairs 202, 203, and 204 in the conveyance path of the sheet M2, as shown in FIG. 2. The sheet M2 fed in the feeding direction D3 by the feeding roller 201 is conveyed in the conveyance path of the sheet M2 by the multiple conveying roller pairs such as the conveying roller pairs 202, 203, and 204, and is discharged to a discharge tray 210.

The conveyance path of the sheet M2 is provided with the conveying roller pairs 202, 203, and 204 sequentially in the upstream-downstream conveyance direction, and is further provided with a detector 207, which is disposed between the conveying roller pair 202 and the conveying roller pair 203 and detects the leading end and the trailing end of the sheet M2 in the conveyance direction, as shown in FIG. 2.

A platen 206 is provided between the conveying roller pair 203 and the conveying roller pair 204 in the conveyance path of the sheet M2, and a head 205 mounted on a carriage 211 is provided at a position where the head 205 faces the platen 206, as shown in FIG. 2. The head 205 in the present embodiment is an inkjet head that ejects ink while moving in the width direction (X-axis direction), which intersects with the conveyance direction of the sheet M2. Note, however, that the image forming unit described above does not necessarily have a specific configuration, and may be what is called a linear head having nozzles via each of which ink is ejected and which are provided so as to cover the entire medium in the width direction, or may have a configuration in which toner is used to form an image in place of the configuration in which liquid ink is ejected to form an image.

The image forming apparatus body section 200 in the present embodiment discharges the sheet M2, onto which ink is ejected from the head 205 to form an image, to the discharge tray 210 with the aid of the conveying roller pair 204. That is, the conveying roller pair 204 also serves as a discharger. Note that the image forming apparatus body section 200 in the present embodiment can record an image on the sheet M2 based on recorded data transmitted from a computer that is not shown or the like, and can also record an image of the document M1 read by the image reader 100A on the sheet M2.

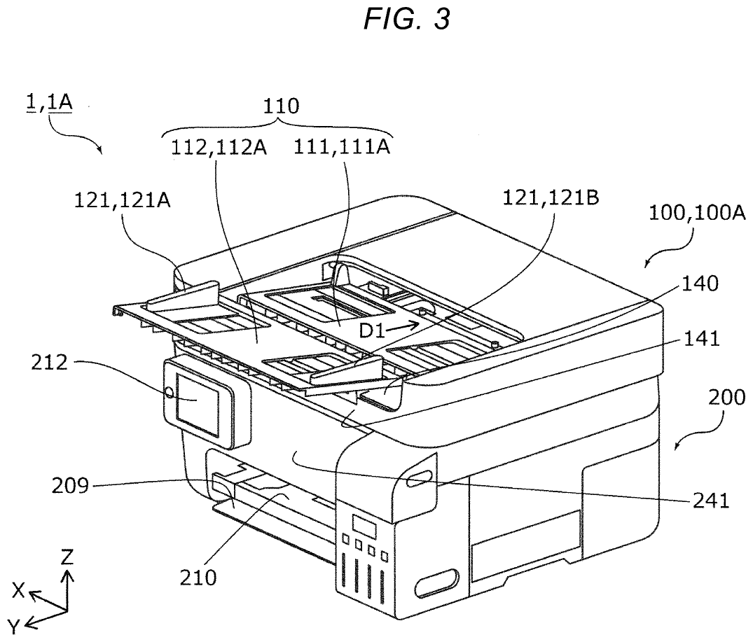

The image reader 100A in the present embodiment includes a tray 110, on which the document M1, from which an image is read, is placed, as shown in FIGS. 1 to 3. The tray 110 is provided in an upper portion of the image forming apparatus body section 200. A comparison of FIG. 1 with FIGS. 2 and 3 shows that the tray 110 includes a body tray 111 (body tray 111A) and an extractable tray 112 (extractable tray 112A), which is extractable with respect to the body tray 111A in the +Y direction, which is the first direction side, from a stored position shown in FIG. 1 to an extracted position shown in FIGS. 2 and 3.

The image reader 100A in the present embodiment includes a feeding roller 131 including a separating roller 131A, which prevents multiple documents M1 from being fed at once, as shown in FIG. 2. The document M1 placed on the tray 110 is fed in the feeding direction D1 by the feeding roller 131. The image reader 100A includes a conveying roller pair 132 in the conveyance path of the document M1, as shown in FIG. 2. The document M1 fed in the feeding direction D1 by the feeding roller 131 is conveyed along the conveyance path of the document M1 by the conveying roller pair 132, and is discharged to a discharge tray 140.

The image reader 100A in the present embodiment includes a scanner 150 capable of reading an image of the document M1, as shown in FIG. 2. The conveying roller pair 132 is provided in the conveyance path of the document M1, and a reading position 152, where the image of the document M1 can be read by the scanner 150, is provided downstream from the conveying roller pair 132 in the conveyance direction of the document M1.

The document M1 from which the image thereof has been read by the scanner 150 is conveyed along the conveyance path of the document M1 and discharged to the discharge tray 140. Note that the image reader 100A in the present embodiment includes the scanner 150, which is a flatbed scanner, and is configured to allow the user to place the document M1 at the upper surface of the scanner 150 by causing a conveyance path section 151 having the conveyance path of the document M1 to pivot with respect to the scanner 150 around a pivotal axis along the X-axis direction. Note, however, that the scanner 150 and other portions do not necessarily have specific configurations.

The image reader 100A in the present embodiment includes a document edge guide 121, as shown in FIGS. 1 and 3. Specifically, the document edge guide 121 includes document edge guides 121A and 121B, which are both movable in the width direction, which intersects with the feeding direction of the document M1, and the document edge guides 121A and 121B are both provided at the extractable tray 112A, which can be located on the front side of the apparatus. There is therefore no obstacle on the +Y direction side (front side of image forming apparatus 1A), which is the first direction side corresponding to the front side of the apparatus, and both the document edge guides 121A and 121B are configured to be operable from the first direction side.

As described above, since the document edge guide 121 in the present embodiment is configured to be operable from the first direction side, the user can access the document edge guide 121 from the first direction side corresponding to the front side of the apparatus, which can improve the operability of the document edge guide 121 to be moved in the width direction. The thus configured image reader 100A in the present embodiment can improve the operability of the document edge guide 121 to be moved in the width direction, for example, even when the apparatus is installed in a space having a small space above the apparatus.

The extractable tray 112A in the image reader 100A in the present embodiment is disposed above the body tray 111A in the image reader 100A in the present embodiment when the extractable tray 112A is at the stored position shown in FIG. 1. The document edge guides 121A and 121B are both disposed at the extractable tray 112A. The thus configured image forming apparatus 1A according to the present embodiment allows improvement in the operability of the document edge guide 121 to be moved in the width direction not only when the document edge guide 121 is at the extracted position shown in FIGS. 2 and 3 but also when the document edge guide 121 is at the stored position shown in FIG. 1. This is because there is no blocking object on the front side of the apparatus (+Y direction side) even when the document edge guide 121 is at the stored position.

In the image forming apparatus 1A according to the present embodiment, when viewed from above with the extractable tray 112A being at the extracted position, at least a portion of the document edge guide 121 is located at a position shifted toward the first direction side (+Y direction side) from an enclosure surface 141 of the image reader 100A, which is a surface on the first direction side, as shown in FIG. 3. The thus configured image forming apparatus 1A according to the present embodiment allows the user to readily access the document edge guide 121 from the first direction side corresponding to the front side of the apparatus, which can particularly improve the operability of the document edge guide 121 to be moved in the width direction.

The image forming apparatus 1A according to the present embodiment includes the operation panel 212, which serves as an operation section that accepts an operation instruction from the user, as shown in FIGS. 1 and 3. The operation panel 212 is disposed at an enclosure surface 241 of the image forming apparatus body section 200 shown in FIG. 1, which is a surface on the first direction side. It is preferable that the operation section, which accepts an operation instruction from the user, is disposed at the enclosure surface 241 of the image forming apparatus body section 200, which is a surface on the first direction side, or the enclosure surface 141 of the image reader 100, which is a surface on the first direction side, as in the image forming apparatus 1A according to the present embodiment. The configuration described above allows improvement in the operability of the operation section in addition to the operability of the document edge guide 121 to be moved in the width direction.

### Second Embodiment

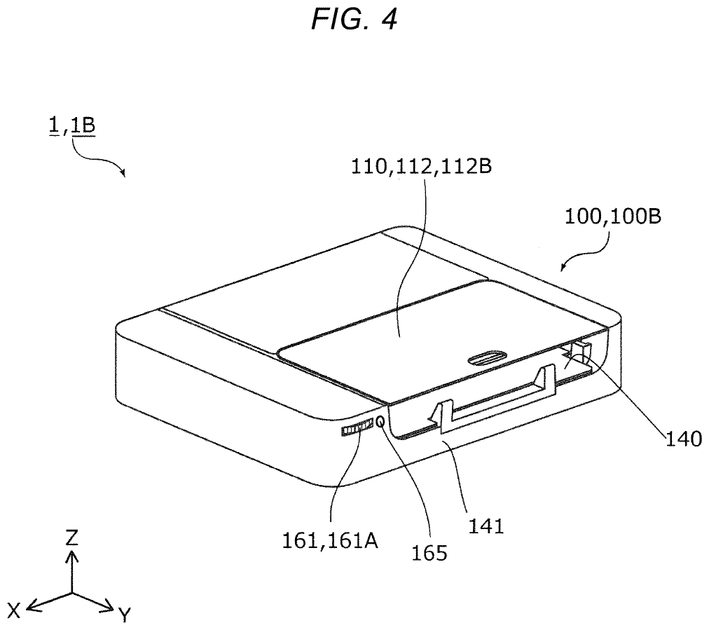

An image forming apparatus 1B according to a second embodiment will next be described with reference to FIGS. 4 to 7. In FIGS. 4 to 7, constituent members common to those in the first embodiment described above have the same reference characters, and no detailed description thereof will be made. The image forming apparatus 1B according to the present embodiment is configured in the same manner as the image forming apparatus 1A according to the first embodiment except for the configuration of the image reader 100 (image reader 100B). The image forming apparatus 1B according to the present embodiment therefore has features that are the same as those of the image forming apparatus 1A according to the first embodiment except for the portions described below.

The image forming apparatus 1A according to the first embodiment includes the document edge guide 121 at the extractable tray 112 (extractable tray 112A), as shown in FIGS. 1 to 3. On the other hand, in the image forming apparatus 1B according to the present embodiment, the document edge guide 121 is not provided at the extractable tray 112 (extractable tray 112B) but is provided at the body tray 111 (body tray 111B). The image forming apparatus 1B according to the present embodiment further includes a moving unit 160, which moves the document edge guide 121 in the width direction.

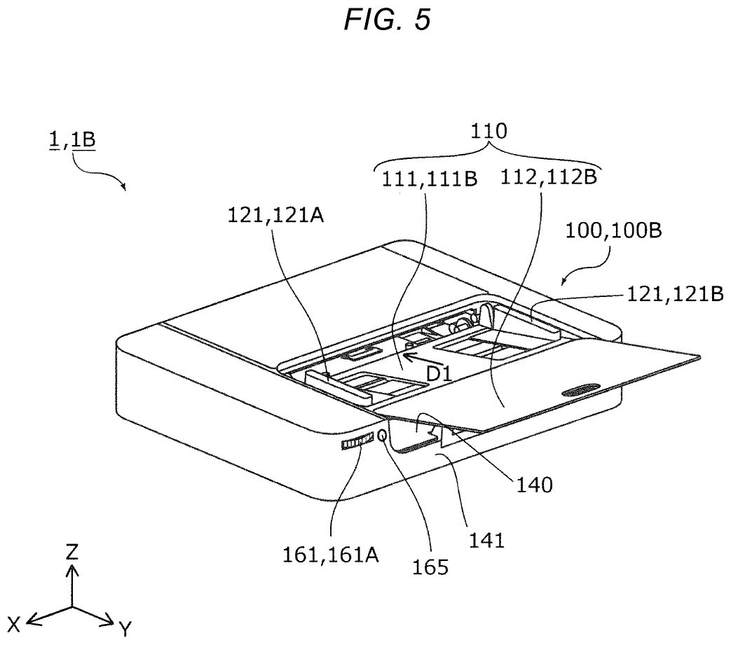

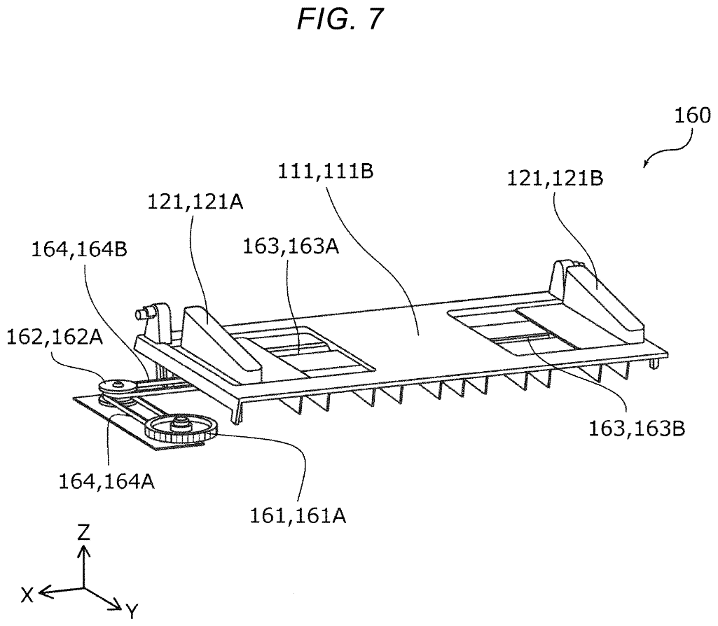

Specifically, the image forming apparatus 1B according to the present embodiment includes a rotary dial 161A as an operation section 161, which can be manually operated by the user, and the moving unit 160 linked to the operation section 161 and the document edge guide 121. Note that the operation section 161 can also be regarded as a portion of the moving unit 160. Both the document edge guides 121A and 121B as the document edge guide 121 are disposed at the body tray 111, as shown in FIGS. 5 and 7, and the operation section 161 is disposed at the enclosure surface 141 of the image reader 100B in the present embodiment, which is a surface on the first direction side (+Y direction side), as shown in FIGS. 4 and 5.

The thus configured image forming apparatus 1B according to the present embodiment allows the document edge guide 121 to be moved via the operation section 161. Furthermore, the operation section 161 can be readily accessed from the first direction side (+Y direction side) corresponding to the front side of the apparatus (side in front of apparatus), and the operability of the document edge guide 121 to be moved in the width direction can be particularly improved.

In other words, the operation section 161 used to operate the document edge guide 121 is provided at a position where the operation section 161 does not overlap with the tray 110 when viewed from the front side of the apparatus (+Y direction side). Note that the configuration in which the operation section 161 is disposed at the enclosure surface 141 on the front side of the apparatus means that the user only needs to be able to access the operation section 161 from the front side of the apparatus (+Y direction side), and further means that the operation section 161 is provided, for example, at any position within a wide range including both the enclosure surface 141 and an enclosure surface extending in the X-axis direction.

The operation section 161 in the present embodiment is the rotary dial 161A, as described above. The user can readily move the document edge guide 121 by rotating the thus configured operation section 161.

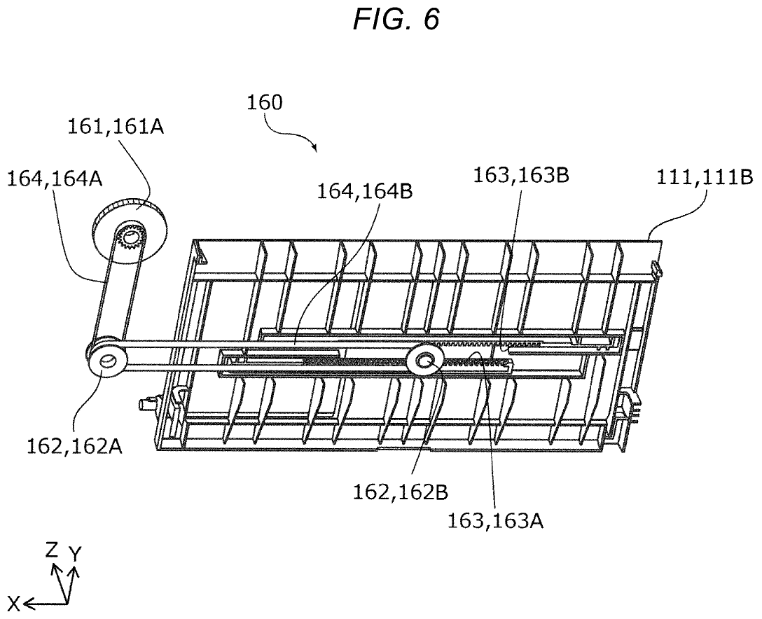

The configuration of the moving unit 160 will now be described in detail. The moving unit 160 includes a first pulley 162A as a pulley 162, and the first pulley 162A is coupled to the rotary dial 161A via a first endless belt 164A as an endless belt 164, as shown in FIGS. 6 and 7. The moving unit 160 further includes a rack 163A integrated with the document edge guide 121A, a rack 163B integrated with the document edge guide 121B, and a pinion 162B, which is a gear engaging with the two racks 163 (rack 163A and rack 163B), as shown in FIG. 6. When the pinion 162B rotates, the document edge guide 121A and the document edge guide 121B move along the width direction via the rack 163A and the rack 163B.

The pinion 162B also serves as the pulley 162, and is coupled to the first pulley 162A via a second endless belt 164B as the endless belt 164. The configuration described above allows the user to manually rotate the rotary dial 161A to rotate the first pulley 162A, the pinion 162B rotates when the first pulley 162A rotates, and the document edge guide 121A and the document edge guide 121B move along the width direction (X-axis direction) via the rack 163A and the rack 163B when the pinion 162B rotates. When the document edge guide 121A moves in the +X direction, the document edge guide 121B moves in the −X direction, and when the document edge guide 121A moves in the −X direction, the document edge guide 121B moves in the +X direction.

In other words, in the image forming apparatus 1B according to the present embodiment, the operation section 161 is the rotary dial 161A. The rotary dial 161A is configured to be capable of moving the document edge guide 121 in the width direction (X-axis direction) via the first endless belt 164A, the first pulley 162A, the second endless belt 164B, the pinion 162B, the rack 163A, and the rack 163B. As described above, since the operation section 161 is the rotary dial 161A, and the rotary dial 161A is configured to be capable of moving the document edge guide 121 in the width direction via at least one of a belt, a pulley, or a gear, the operation section 161 can have a simple configuration and can be reduced in size.

Note that the moving unit 160 in the present embodiment is configured to allow the user to move the document edge guide 121 (configured with two document edge guides 121A and 121B) in the width direction by operating the single operation section 161 (rotary dial 161A), but is not necessarily configured as described above. For example, two operation sections 161 may be provided, and the document edge guide 121A and the document edge guide 121B may be moved by the user operating the respective operation sections 161. Furthermore, the document edge guides 121A and 121B can be moved not only via the operation section 161 but also by direct operation of the document edge guides 121A and 121B.

The image forming apparatus 1B according to the present embodiment includes a light emitter 165, which is disposed near the operation section 161 and indicates the rotary position of the operation section 161, as shown in FIGS. 4 and 5. The light emitter 165 in the present embodiment is configured to emit light when the extractable tray 112B is extracted to the extracted position. As described above, employing a configuration in which the light emitter 165 indicating the rotary position of the operation section 161 is provided at the operation section 161 or near the operation section 161 allows the user to readily recognize the rotary position of the operation section 161 used to move the document edge guide 121. Note that the light emitter 165 does not necessarily have a specific configuration, and a light emitting diode (LED) or the like can be preferably used.

### Third Embodiment

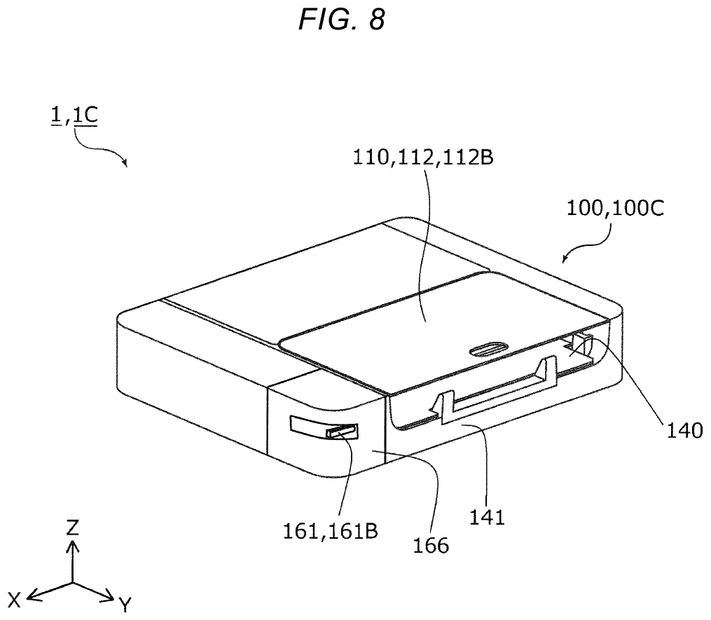

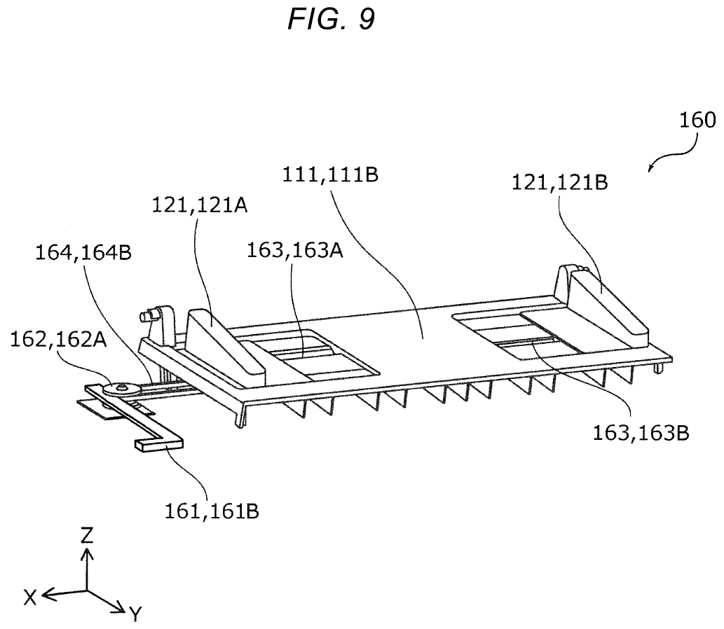

An image forming apparatus 1C according to a third embodiment will next be described with reference to FIGS. 8 and 9. In FIGS. 8 and 9, constituent members common to those in the first and second embodiments described above have the same reference characters, and no detailed description thereof will be made. Note that FIG. 8 corresponds to FIG. 4 showing the image forming apparatus 1B according to the second embodiment, and FIG. 9 corresponds to FIG. 7 showing the image forming apparatus 1B according to the second embodiment. The image forming apparatus 1C according to the present embodiment is configured in the same manner as the image forming apparatus 1A according to the first embodiment and the image forming apparatus 1B according to the second embodiment except for the configuration of the image reader 100 (image reader 100C). The image forming apparatus 1C according to the present embodiment therefore has the same features as the image forming apparatuses 1 according to the first and second embodiments except for the portions described below.

In the image forming apparatus 1B according to the second embodiment, the operation section 161 is the rotary dial 161A, as shown in FIGS. 4 to 7. On the other hand, in the image forming apparatus 1C according to the present embodiment, the operation section 161 is a lever 161B movable in the frontward-rearward direction along the Y-axis direction, as shown in FIGS. 8 and 9. The thus configured image forming apparatus 1C according to the present embodiment allows the user to readily move the document edge guide 121 by moving the operation section 161 in the frontward-rearward direction along the Y-axis direction.

In the image forming apparatus 1C according to the present embodiment, the lever 161B also serves as a rack, and the user can move the lever 161B along the Y-axis direction, as shown in FIG. 9. The moving unit 160 of the image reader 100C in the present embodiment includes the first pulley 162A, which also serves as a pinion that is a gear coupled to the lever 161B. The moving unit 160 of the image reader 100C in the present embodiment further includes the rack 163A integrated with the document edge guide 121A, the rack 163B integrated with the document edge guide 121B, and the pinion 162B, which is a gear engaging with the rack 163A and the rack 163B, as the moving unit 160 of the image reader 100B in the second embodiment. When the pinion 162B rotates, the document edge guide 121A and the document edge guide 121B move along the width direction via the rack 163A and the rack 163B. Note also in the image forming apparatus 1C according to the present embodiment that the document edge guides 121A and 121B can be moved not only via the operation section 161 but also by direct operation of the document edge guides 121A and 121B.

In the moving unit 160 of the image reader 100C in the present embodiment, the pinion 162B also serves as the pulley 162, and is coupled to the first pulley 162A via the second endless belt 164B as the endless belt 164, as the moving unit 160 of the image reader 100B in the second embodiment. The configuration described above allows the user to manually move the lever 161B in the forward-rearward direction to rotate the first pulley 162A, the pinion 162B rotates when the first pulley 162A rotates, and the document edge guide 121A and the document edge guide 121B move along the width direction via the rack 163A and the rack 163B when the pinion 162B rotates.

As described above, the operation section 161 of the image forming apparatus 1C according to the present embodiment is the lever 161B, and the lever 161B is configured to be capable of moving the document edge guide 121 in the width direction (X-axis direction) via the first pulley 162A, the second endless belt 164B, the pinion 162B, the rack 163A, and the rack 163B. As described above, since the operation section 161 is the lever 161B, and the lever 161B is configured to be capable of moving the document edge guide 121 in the width direction (X-axis direction) via at least one of a belt, a pulley, or a gear, the operation section 161 can have a simple configuration and can be reduced in size.

The image forming apparatus 1C according to the present embodiment includes a transparent region 166 around the operation section 161, as shown in FIG. 8. As described above, employing a configuration in which a transparent or semitransparent portion is provided around the operation section 161 allows the user to readily recognize the position of the operation section 161 used to move the document edge guide 121.

### Fourth Embodiment

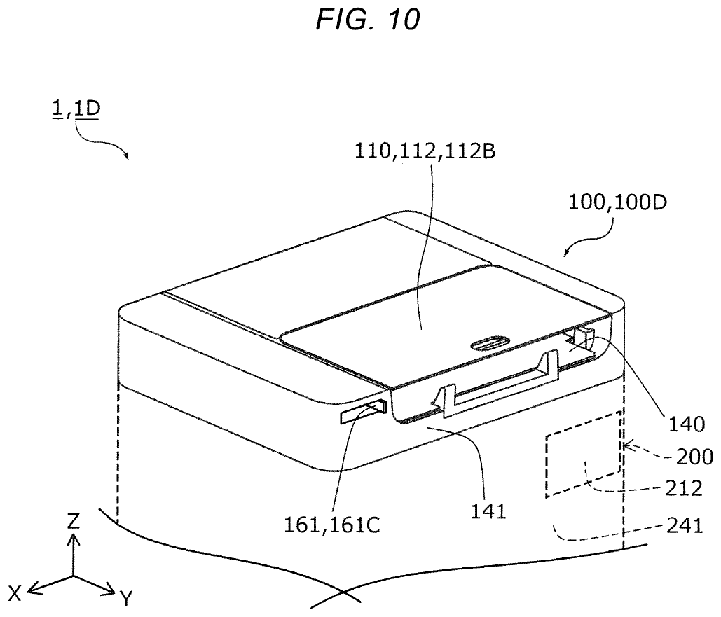

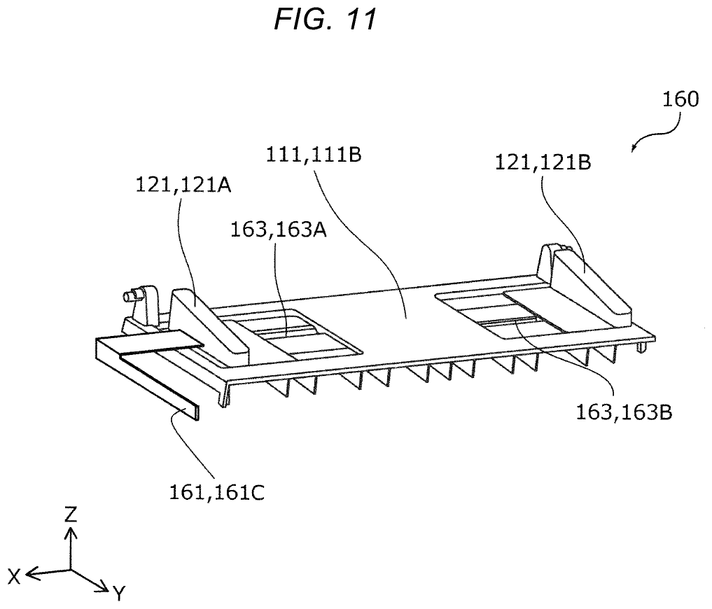

An image forming apparatus 1D according to a fourth embodiment will next be described with reference to FIGS. 10 and 11. In FIGS. 10 and 11, constituent members common to those in the first to third embodiments described above have the same reference characters, and no detailed description thereof will be made. Note that FIG. 10 corresponds to FIG. 4 showing the image forming apparatus 1B according to the second embodiment and shows a portion of the image forming apparatus body section 200 indicated by the broken line, and FIG. 11 corresponds to FIG. 7 showing the image forming apparatus 1B according to the second embodiment. The image forming apparatus 1D according to the present embodiment is configured in the same manner as the image forming apparatuses 1 according to the first to third embodiments except for the configuration of the image reader 100 (image reader 100D) and the arrangement of the operation panel 212. The image forming apparatus 1D according to the present embodiment therefore has features that are the same as those of the image forming apparatuses 1 according to the first to third embodiments except for the portions described below.

The image forming apparatus 1D according to the present embodiment includes the document edge guide 121 configured with the multiple document edge guides 121A and 121B, and includes a lever 161C as the operation section 161, as the image forming apparatuses 1 according to the first to third embodiments. The lever 161C is integrated with the document edge guide 121A, and is therefore configured to be movable along the width direction (X-axis direction) along with the document edge guide 121A, as shown in FIG. 11. As described above, configuring the document edge guide 121 with multiple document edge guides and integrating the operation section 161 with at least one of the document edge guides that constitute the document edge guide 121 allows elimination of the need to provide a section that links the operation section 161 to the document edge guide 121. Therefore, the number of parts can be reduced, and an increase in size of the apparatus can be suppressed. Note also in the image forming apparatus 1D according to the present embodiment that the document edge guides 121A and 121B can be moved not only via the operation section 161 but also by direct operation of the document edge guides 121A and 121B.

Specifically, the image forming apparatus 1D according to the present embodiment includes the lever 161C integrated with the document edge guide 121A, and the document edge guide 121A and the document edge guide 121B are coupled to each other via the pinion 162B, the rack 163A, and the rack 163B, as the moving unit 160 of each of the image forming apparatuses 1 according to the first to third embodiments. Therefore, when the lever 161C is moved in the width direction (X-axis direction) to move the document edge guide 121A in the width direction, the rack 163A also moves in the width direction along with the document edge guide 121A, the pinion 162B rotates, the rack 163B moves in the width direction when the pinion 162B rotates, and the document edge guide 121B also moves in the width direction along with the rack 163B.

Note in the image forming apparatus 1D according to the present embodiment that the operation panel 212 as the operation section that accepts an operation instruction from the user is disposed at the enclosure surface 241 of the image forming apparatus body section 200, which is a surface on the first direction side, which is the side (−X direction side) different in the width direction (X-axis direction) from the side (+X direction side) on which the operation section 161 is provided, as indicated by the broken line in FIG. 10. As described above, it is preferable that the operation section (operation panel 212), which accepts an operation instruction from the user, is disposed at the enclosure surface 241 of the image forming apparatus body section 200, which is a surface on the first direction side, or at the enclosure surface 141 of the image reader 100, which is a surface on the first direction side, which is the side different in the width direction from the side on which the operation section 161 is provided. The configuration described above allows improvement in the operability of the operation section (operation panel 212) in addition to the operability of the document edge guide 121 to be moved in the width direction, and further allows the user to use the operation section 161 while viewing the operation section (operation panel 212) without the field of view being blocked by the user's hand or the like.

In the image forming apparatus 1D according to the present embodiment, the entire extractable tray 112B is made of transparent resin. As described above, employing the configuration in which the extractable tray 112 is provided with the transparent or semitransparent region allows the user to readily recognize the position of the document edge guide 121 after it is moved from the front side of the apparatus (+Y direction side) through the extractable tray 112.

The present disclosure is not limited to the embodiments and the variations thereof described above. Various other variations are conceivable within the scope of the disclosure described in the claims. It is obvious that the variations are also encompassed within the scope of the present disclosure.

What is claimed is:

1. An image forming apparatus operable from a first direction side, the image forming apparatus comprising:
an image forming apparatus body section configured to feed a sheet in a direction from the first direction side toward a second direction side opposite the first direction side, and discharge the sheet in a direction from the second direction side toward the first direction side; and
an image reader configured to feed a document in the direction from the first direction side toward the second direction side, and discharge the document in the direction from the second direction side toward the first direction side,
wherein the image reader is provided in an upper portion of the image forming apparatus body section, and includes a body tray, an extractable tray extractable with respect to the body tray toward the first direction side from a stored position to an extracted position, and a document edge guide movable in a width direction that intersects with a feeding direction of the document, and
the document edge guide is configured to be operable from the first direction side.

2. The image forming apparatus according to claim 1, wherein
the extractable tray is located above the body tray when the extractable tray is in the stored position, and
the document edge guide is disposed at the extractable tray.

3. The image forming apparatus according to claim 2, wherein
when the image forming apparatus is viewed from above in a state in which the extractable tray is located at the extracted position, at least a portion of the document edge guide is located at a position shifted toward the first direction side from an enclosure surface of the image reader that is a surface on the first direction side.

4. The image forming apparatus according to claim 1, further comprising:
a manually operable operation section; and
a moving unit linked to the operation section and the document edge guide,
wherein the document edge guide is disposed at the body tray, and
the operation section is disposed at an enclosure surface of the image reader that is a surface on the first direction side.

5. The image forming apparatus according to claim 4, wherein
the operation section is a rotary dial or a lever.

6. The image forming apparatus according to claim 5, wherein
the operation section is the rotary dial, and
the rotary dial is configured to move the document edge guide in the width direction via at least one of a belt, a pulley, or a gear.

7. The image forming apparatus according to claim 5, wherein
the operation section is the lever, and
the lever is configured to move the document edge guide in the width direction via at least one of a belt, a pulley, or a gear.

8. The image forming apparatus according to claim 4, wherein
the document edge guide is configured with multiple document edge guides, and
the operation section is integrated with at least one of the document edge guides.

9. The image forming apparatus according to claim 1, further comprising
an operation section configured to accept an operation instruction,
wherein the operation section is disposed at an enclosure surface of the image forming apparatus body section that is a surface on the first direction side or an enclosure surface of the image reader that is a surface on the first direction side.

10. The image forming apparatus according to claim 4, further comprising
an operation section configured to accept an operation instruction,
wherein the operation section is disposed at an enclosure surface of the image forming apparatus body section that is a surface on the first direction side or an enclosure surface of the image reader that is a surface on the first direction side, which is a side different in the width direction from a side on which the operation section is provided.

11. The image forming apparatus according to claim 4, further comprising
a light emitter at or near the operation section,
wherein the light emitter is configured to emit light when the extractable tray is extracted to the extracted position.

12. The image forming apparatus according to claim 4, wherein
a transparent or semitransparent region is provided around at least one of the extractable tray or the operation section.
